(19) United States
(12) Patent Application Publication
(10) Pub. No.: US 2021/0375076 A1
(43) Pub. Date: Dec. 2, 2021

(54) ANALYTICS PLATFORM FOR REMOTE VEHICLE ONBOARD DIAGNOSTICS (OBD) AND INSPECTION MAINTENANCE (I/M)

(71) Applicant: 4.0 Analytics, Inc., Newark, NJ (US)

(72) Inventors: Mark L. SCOTLAND, Newark, NJ (US); Gloria J. COWART, Newark, NJ (US)

(73) Assignee: 4.0 Analytics, Inc., Newark, NJ (US)

(21) Appl. No.: 17/332,783

(22) Filed: May 27, 2021

Related U.S. Application Data
(60) Provisional application No. 63/030,822, filed on May 27, 2020.

(51) Int. Cl. G07C 5/00; G07C 5/08

(52) U.S. Cl. CPC G07C 5/008; G07C 5/0808; G07C 5/006

(57) ABSTRACT

Remote diagnoses of a vehicle comprises periodically receiving, by one or more servers, vehicle metrics transmitted wirelessly over a communication network from a remote data logger device in the vehicle. The vehicle metrics are analyzed by the server to determine at least one of i) whether the vehicle is compliant with predefined emissions standards, and ii) whether a component of the vehicle is progressing towards a failure based on predictive analytics. Results of the analysis are electronically communicated to a user by the server.

### CROSS-REFERENCE TO RELATED APPLICATIONS

This application claims priority to U.S. Provisional Patent Application No. 63/030,822, filed May 27, 2020, the entire disclosure of which is incorporated herein by reference.

### BACKGROUND

On-board diagnostics (OBD) refers to a vehicle's self-diagnostic and reporting capability. OBD systems give the vehicle owner or repair technician access to the status of the various vehicle sub-systems. The amount of diagnostic information available via OBD has varied since its introduction in the early 1980s versions of on-board vehicle computers. Early versions of OBD would simply illuminate a check engine light (CEL), also known as a malfunction indicator light (MIL) or an “idiot light”, if a problem was detected but would not provide any information as to the nature of the problem. Modern OBD implementations use a standardized digital communications port to provide real-time data in addition to a standardized series of diagnostic trouble codes, or DTCs, which allow a person to identify and remedy malfunctions within the vehicle.

Currently, the process requires a CEL issue to be brought into a repair shop so a diagnostic scan tool or diagnostic equipment can be utilized to access the diagnostic trouble codes and perform a diagnostic trouble tree process to attempt to identify the problems source. Unfortunately, repair techs do not have access to data that evaluates what is occurring while the vehicle is on the road and under load. For example, intermittent issues can trigger a CEL while on the road during certain driving conditions, then disappear, and not reappear until the vehicle is back on the road under load. Repair technicians currently have little to no visibility into this situation.

OBD-I attempted to encourage auto manufacturers to design reliable emission control systems that remain effective for the vehicle's useful life. OBD-1 required annual emissions testing for California, and denying registration to vehicles that did not pass. The thought was that this would encourage drivers to purchase vehicles that would more reliably pass the test. However, OBD-I was largely unsuccessful, as the means of reporting emissions-specific diagnostic information was not standardized. Technical difficulties with obtaining standardized and reliable emissions information from all vehicles led to an inability to implement the annual testing program effectively.

OBD-II is an improvement over OBD-I in both capability and standardization. The OBD-II standard specifies the type of diagnostic connector and its pinout, the electrical signaling protocols available, and the messaging format. As a result of this standardization, a single device can query the on-board computer(s) in any vehicle. However, the vehicle must still be taken to a technician to connect a scan tool to the OBD system and retrieve the DTCs.

### BRIEF SUMMARY

The disclosed embodiments describe an analytics platform for remote vehicle onboard diagnostics (OBD) and inspection maintenance (I/M). Aspects of exemplary environment include receiving, by one or more servers, vehicle metrics transmitted wirelessly over a communication network from a remote data logger device in the vehicle. The vehicle metrics are analyzed by the servers to determine at least one of i) whether the vehicle is compliant with predefined emissions standards, and ii) whether a component of the vehicle is progressing towards a failure based on predictive analytics. Results of the analysis are electronically communicated to a user by the servers through a web portal or through alert messages.

According to the disclosed embodiments, the analytics platform provides consistent remote evaluation of the engine system and related components as well as automated report generation and alert messages, which enable proactive maintenance that saves time, money and lowers carbon emissions. In addition, the analytics platform enables owners of OBD-equipped vehicles to avoid having to get a periodic, physical inspection of their motor vehicle, and yet still comply with, and far exceed, the current requirements for an OBD inspection.

### BRIEF DESCRIPTION OF SEVERAL VIEWS OF THE DRAWINGS

FIG. 1 is a diagram illustrating one embodiment of a remote onboard diagnostics (OBD) system.

FIG. 2 is a flow diagram illustrating a process performed by the analytics cloud platform for remotely diagnosing a vehicle.

FIG. 3 is a diagram illustrating one embodiment of an emission compliance module in further detail.

FIG. 4 is a flow diagram of the processing that may be performed by a check compliance module according to one embodiment.

FIGS. 5A-5F are example screen shots of reports produced by a remote diagnostics module showing how engine and emission system data is captured, plotted and displayed.

FIG. 6 is a table listing components that may be tested for predictive component failure and percentage of failure calculations according to one implementation.

FIGS. 7A-7E are screenshots of an example user interface of the emission compliance portal for displaying emission compliance reports to users.

FIGS. 8A-8C are screenshots of an example user interface for an administrative web portal of the analytics cloud platform for displaying compliance statistics across multiple vehicle fleets.

### DETAILED DESCRIPTION

The disclosed embodiments relate to an analytics platform for remote vehicle onboard diagnostics (OBD) and inspection maintenance (I/M). The following description is presented to enable one of ordinary skill in the art to make and use the invention and is provided in the context of a patent application and its requirements. Various modifications to the exemplary embodiments and the generic principles and features described herein will be readily apparent. The disclosed embodiments are mainly described in terms of particular methods and systems provided in particular implementations. However, the methods and systems will operate effectively in other implementations. Phrases such as “one embodiment” and “another embodiment” may refer to the same or different embodiments. The embodiments will be described with respect to systems and/or devices having certain modules. However, the systems and/or devices may include more or less modules than those shown, and variations in the arrangement and type of the modules may be made without departing from the scope of the invention. The disclosed embodiments will also be described in the context of particular methods having certain steps. However, the method and system operate effectively for other methods having different and/or additional steps and steps in different orders that are not inconsistent with the exemplary embodiments. Thus, the disclosed embodiments are not intended to be limited to the embodiments shown, but is to be accorded the widest scope consistent with the principles and features described herein.

The disclosed embodiments describe an analytics cloud platform for remote vehicle onboard diagnostics (OBD) and inspection maintenance (UM). The analytics cloud platform receives raw OBD data from the vehicle engine and emission systems transmitted from data logger devices. The analytics cloud platform processes the data using data analytics and performs I/M specific functions including determining pass/fail conditions and reporting to users including administrative agencies, repair shops and motorists. The data analytics produces emission/engine compliance test results that are accessible to users through a web portal in private online accounts or are automatically sent to the users. The test result provide users and repair technicians with an ongoing history regarding the health of their vehicles. The analytics cloud platform provides many advantages such as improving fuel efficiency, reducing maintenance/repair cost and reducing carbon emissions.

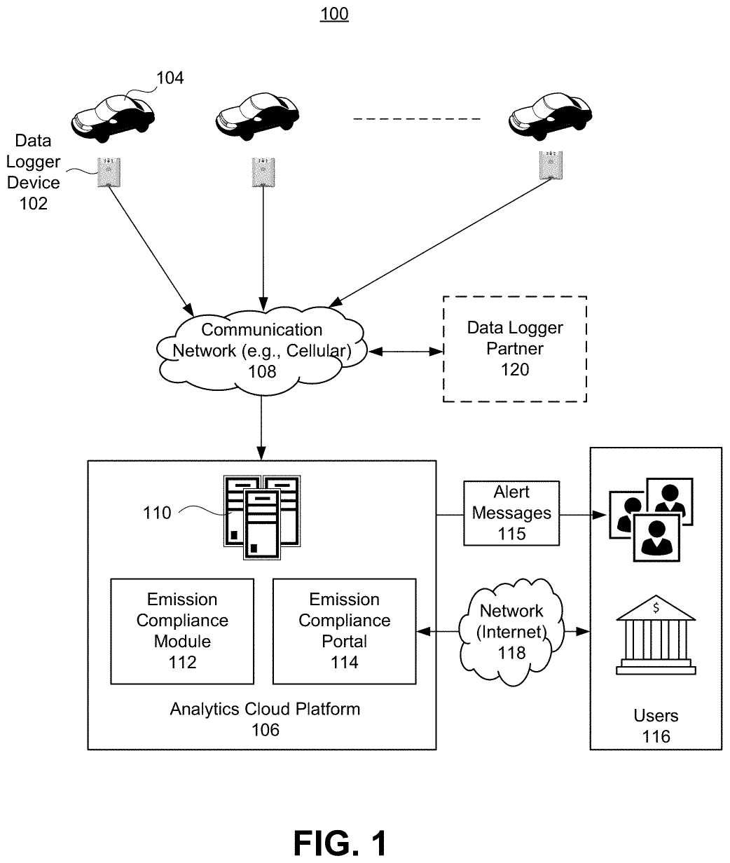

FIG. 1 is a diagram illustrating one embodiment of a remote onboard diagnostics (OBD) system. The remote OBD system 100 comprises a data logger device 102 installed in a vehicle 104 or comprises existing on-vehicle telematics to monitor the vehicle OBD system on a substantially continuous basis. As used herein, a data logger device (also called a datalogger or data recorder) is an electronic device (built-in or removable) that records vehicle data over time or in relation to location using internal or external instruments and sensors, and may include an internal digital processor (or computer) internal memory for data storage, and a wireless communication device. The data logger devices 102 may provide complete vehicle history metrics so that the vehicle can be diagnosed any time without the vehicle owner/user having to be prompted by a vehicle light. In embodiments, at least a portion of the vehicle metrics may comprise OBD data, such as vehicle engine and emission system data.

The data logger device 102 wirelessly transmits collected vehicle metric data to a remote analytics cloud platform 106 over a communication network 108 periodically. The communication network may comprise a cellular/satellite network, a dedicated short-range communication (DSRC), and/or a wireless network such as Wi-Fi. In one embodiment, the remote OBD system 100 may require that approximately 70-90% of the data logger devices 102 communicate with the analytics cloud platform 106 at least once every 10-20 days, while the other 30%-10% communicate with the analytics cloud platform 106, at least once per month.

In one embodiment, the data logger devices 102 may be provided by a data logger partner 120 independent of the analytics cloud platform 106. In this embodiment, the data from the data logger devices 102 may be first sent to a system of the data logger partner 120 and then forwarded by the data logger partner 120 to the analytics cloud platform 106. In another embodiment, the data logger devices 102 may be provided by an entity that own or controls the analytics cloud platform 106.

According to the disclosed embodiments, the analytics cloud platform 106 combines software, IoT, mobility, big-data & remote analytics to change the emissions compliance & maintenance paradigm in the auto industry, resulting in significant savings (fuel, maintenance, productivity) to users and a major positive impact on the environment.

The analytics cloud platform 106 comprises one or more servers 110 that communicate with the wireless communication devices of the data logger devices 102, an emission compliance module 112 and an emission compliance portal 114. Vehicle metrics transmitted from the data logger devices 102 are analyzed by the emission compliance module 112 to enable the analytics cloud platform 106 to perform real-time monitoring of the vehicle health while the vehicle is in operation. For example, the analytics cloud platform 106 may perform remote OBD inspection maintenance (UM), which as used herein, refers to wireless, substantially continuous OBD testing.

In addition to a conventional idle reduction system module, the check compliance module 300 may perform/comprise a plurality of functions/modules including: remote inspection maintenance (UM) pass/fail emissions testing, enhanced engine diagnostics, reporting to State I/M emissions programs, or any combination thereof. Users 116 of the analytics cloud platform 106 may be offered the option of utilizing one functions/module or the entire suite of functions/modules.

The analytics cloud platform 106 may also include an emission compliance portal 114 to communicate the results of the analysis performed by the emission compliance module 112 to users 116 over a network 118, such as the Internet. In one embodiment, the users 116 can log into the analytics cloud platform 106 to the emission compliance portal 114 to view the diagnoses and analytics about their vehicles 104. The emission compliance portal 114 may be configured to provide reporting, data visualization and account management functions. In another embodiment, the emission compliance portal 114 may send the reports or links to the reports directly to users 116, e.g., via email or text messaging.

In embodiments, the users 116 of the analytics cloud platform 106 may include owners/drivers of the vehicles, public and private auto fleets, auto repair shops, usage-based insurance customers, automobile diagnostic providers, vehicle data aggregators, government authorities (e.g., State Department of Motor Vehicles (DMV) or government emission test programs), and any combination thereof.

The analytics cloud platform 106 may be configured to automatically generate and send alert messages 115 to appropriate users 116 when the OBD and I/M analysis indicates the vehicle is noncompliant and/or that a component of the vehicle is progressing towards failure. The alert messages 115 may be sent with optional corresponding diagnostic data. The purpose of the alert messages 115 is for the users 116 to seek a remedy to avoid expensive failures. In one embodiment, the alert messages may be sent by the emission compliance module 112, while in another embodiment, the alert messages 115 may be sent by the emission compliance portal 114.

The remote OBD system 100 offers the opportunity for owners of OBD-equipped vehicles to avoid having to get a periodic, physical inspection of their motor vehicle, and yet still comply with the requirements for an OBD inspection. Due to the continuous nature of remote OBD, as opposed to the annual or biennial tests now done in periodic I/M programs, the remote OBD system 100 can find problems with motor vehicles more quickly, leading to faster repairs and, thus, more emission benefits. In addition, continuous monitoring allows the program to specify more stringent readiness criteria than a periodic program. This means determining the malfunction indicator light (MIL) is off and all monitors are ready prior to concluding that a vehicle is repaired, and in the case of persistent failure to set readiness, allows for corrective action.

The server(s) 112 of the analytics cloud platform 106 may comprise a server computer system, which includes hardware modules of typical computing devices (not shown), including processors, input devices and output devices, such as wired or wireless network communication interfaces for communication. The server computer system may include internal and external non-transitory computer-readable media, e.g., memory and storage devices (e.g., flash memory, hard drive, optical disk drive, magnetic disk drive, and the like) containing both data and computer instructions. The computer instructions implement the functionality disclosed herein when executed.

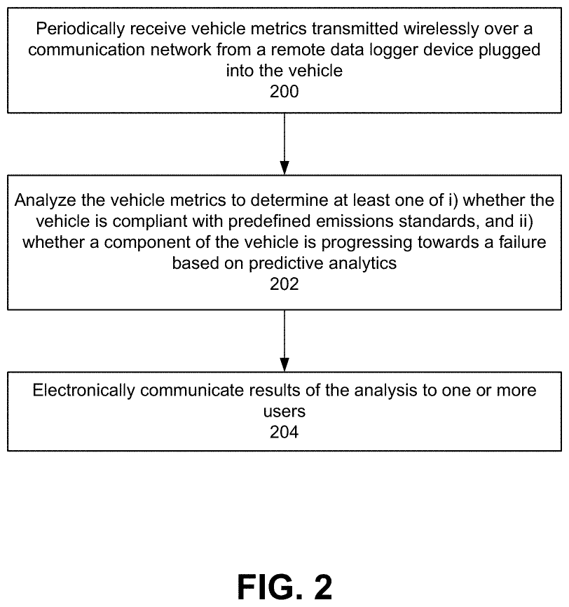

FIG. 2 is a flow diagram illustrating a process performed by the analytics cloud platform for remotely diagnosing a vehicle. The process includes the server(s) 110 periodically receiving vehicle metrics transmitted wirelessly over a communication network from a remote data logger device in the vehicle (block 200).

Some types of data logger devices 102 may be installed in the vehicles 104 by plugging into a port, such as an OBDII port, inside the vehicle. Other types of data logger devices 102 may be built or hardwired into the vehicle. Upon vehicle ignition in the Key On Engine Running (KOER) position, multiple times each hour, specific raw OBD data sets are extracted by the data logger device.

According to one implementation, the data logging devices 102 may collect raw OBD data as the vehicle metrics and compile the raw OBD data into an OBD test record in a format defined and/or accepted by the analytics cloud platform 106. The OBD test record is then transmitted by the data logging devices 102 and received by the analytics cloud platform 106.

Table 1 summarizes the vehicle-generated data fields that may be collected and formed into an OBD test record.

TABLE I
OBD Test Record Fields

| # | Field Description |
|---|---|
| 1 | Device Serial Number |
| 2 | Electronic Vehicle Identification Number |
| 3 | Date of Data Collection |
| 4 | Time of Data Collection |
| 5 | Communications Protocol |
| 6 | MIL Commanded On |
| 7 | OBD Monitor Status - Catalyst |
| 8 | OBD Monitor Status - Evap |
| 9 | OBD Monitor Status - Secondary Air |
| 10 | OBD Monitor Status - Oxygen Sensor |
| 11 | OBD Monitor Status - Oxygen Sensor Heater |
| 12 | OBD Monitor Status - EGR |
| 13 | OBD Monitor Status - Comprehensive Components |
| 14 | OBD Monitor Status - Fuel System |
| 15 | OBD Monitor Status - Misfire |
| 16 | OBD Monitor Status - Air Conditioning |
| 17 | OBD Monitor Status - Catalyst Heater |
| 18 | Engine RPM |
| 19 | PID Count |
| 20 | PCM ID |
| 21 | Calibration ID |
| 22 | Calibration Verification Number |
| 23 | Diagnostic Trouble Code 1 |
| 24 | Diagnostic Trouble Code 2 |
| 25 | Diagnostic Trouble Code 3 |
| 26 | Diagnostic Trouble Code 4 |
| 27 | Diagnostic Trouble Code 5 |
| 28 | Diagnostic Trouble Code 6 |
| 29 | Diagnostic Trouble Code 7 |
| 30 | Diagnostic Trouble Code 8 |
| 31 | Diagnostic Trouble Code Count |
| 32 | Pending Diagnostic Trouble Code 1 |
| 33 | Pending Diagnostic Trouble Code 2 |
| 34 | Pending Diagnostic Trouble Code 3 |
| 35 | Pending Diagnostic Trouble Code 4 |
| 36 | Pending Diagnostic Trouble Code Count |
| 37 | Permanent Diagnostic Trouble Code 1 |
| 38 | Permanent Diagnostic Trouble Code 2 |
| 39 | Permanent Diagnostic Trouble Code 3 |
| 40 | Permanent Diagnostic Trouble Code 4 |
| 41 | Distance travelled while MIL is activated |
| 42 | Number of warm-ups since DTC cleared |
| 43 | Distance since diagnostic trouble codes cleared |
| 44 | Minutes run by the engine while MIL activated |
| 45 | Time since diagnostic trouble codes cleared |
| 46 | Device Status |
| 47 | Device Firmware Number |

The type and frequency of data collected for processing depends on end user business requirements and features/modules of the emission compliance module 112 that are utilized (i.e. remote emissions, idle reduction system, enhanced remote diagnostics, etc.). For example, a specific user 116 may require at least data from on-board diagnostics (OBD) Parameter ID (PID) codes, as defined by SAE J1979. There are 15 OBD-II PIDs, including live powertrain data values (Mode 01), stored Diagnostic Trouble Codes (DTCs) (Mode 03), on-board monitoring test results for specific monitored systems (Mode 06). In one embodiment, the data logger devices may be configured to poll the data 12 times per hour.

The data logger device 102 may also generate trip and/or event files from the OBD data. Upon Key Off Engine Off (KOEO) each trip of data may be packaged and wirelessly transmitted to the analytics cloud platform 106 for database storage and processing. In another embodiment, each trip of data may be transmitted at the time of capture, such as several times daily for example.

The emission compliance module 112 executed by a computer processor of the server(s) 110 or another computer, analyzes the vehicle metrics to determine at least one of i) whether the vehicle is compliant with predefined emissions standards, and ii) whether a module of the vehicle is progressing towards a failure based on predictive analytics (block 202).

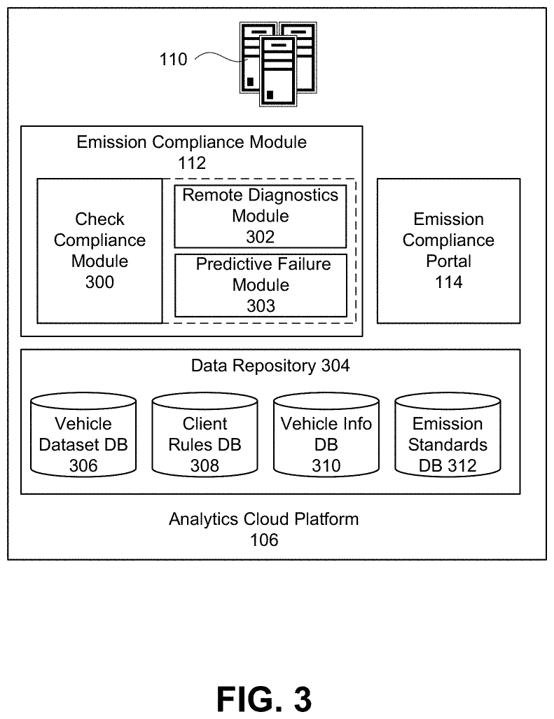

In one embodiment, upon receipt of the vehicle metrics received from the data logger devices 102, the servers 110 may save the vehicle metrics in a data repository (see FIG. 3) in association with a user account. The emission compliance module 112 may retrieve the vehicle metrics for processing. The analysis results are saved back to the data repository under the user account.

After the emission compliance module 112 analyzes the vehicle metrics and saves the analysis results, the emission compliance portal 114 electronically communicates results of the analysis to one or more users through a web portal and/or through alert messages (block 204).

The results of the analysis, such as pass/fails results, may be transferred from the emission compliance module 112 to the emission compliance portal 114 through JSON (JavaScript Object Notation) requests and responses according to one implementation. The users 116 may view the analysis results on their respective computers or mobile devices through a web portal provided by the emission compliance portal 114. In one embodiment, the web portal may be encrypted via industry-standard SSL (Secure Sockets Layer) or TLS (Transport Layer Security).

In one embodiment, emission compliance module 112 may be configured to transmit alert messages sent when specific data fields have values that exceed predefined thresholds, and to transmit the alert messages to not only the owner of the vehicle, but also to a designated repair technician.

The analytics cloud platform 106 enables next generation remote diagnostics emission testing and compliance, eliminating the need, cost, and inconvenience of manual emission testing. Processing of the vehicle data from the data logger devices 102 by the analytics cloud platform 106 results in better vehicle fuel efficiencies, lower maintenance costs and increased vehicle life, providing users 116 for a higher return-on-investment.

FIG. 3 is a diagram illustrating one embodiment of the emission compliance module in further detail, where like modules from FIG. 1 have like reference numerals. In certain implementations, the analytics cloud platform 106 include a data repository 304, and the emissions compliance module 112 may comprise a check compliance module 300, a remote diagnostics module 302, and a predictive failure module 303.

Although the check compliance module 300, the remote diagnostics module 302, the predictive failure module 303, and the emission compliance portal 114 are shown as separate modules, the functionality of each may be combined into a lesser or greater number of modules/modules. In addition, although the server 110 is shown hosting the emission compliance module 112 and the emission compliance portal 114, the emission compliance module 112 and the emission compliance portal 114 may be run on any type of one more computers that have memory and processor.

The data repository 304 may comprise various databases such as for example, a vehicle database 306, a client rules database 308, a vehicle information database 310, and an emissions standards database 312. The vehicle data set database 306 may store vehicle data/metrics received from the data logger devices 102. The client rules database 308 may contain rules associated with the users 116 including configurable thresholds, alarm limits, access rights and the like. The vehicle information database 310 may include vehicle information about different types of vehicles, including nominal emission ranges, temperature ranges and other operating parameters. Emission standards database 312 may include emission compliance standards from one or more government entities. In one embodiment, the databases comprising the data repository 304 may be local to the analytics cloud platform 106. In another embodiment, at least a portion of the databases may reside external to the data repository 304 and accessed remotely.

Because the data logger devices 102 remain plugged inside the vehicles, the check compliance module 300 may be configured to perform emission compliance periodically, e.g., daily, using predefined vehicle metrics and a set of calculations performed on those metrics. The predefined vehicle metrics may be stored in the vehicle data set database 306. The check compliance module 300 calculations may include determining the emissions compliance of a given vehicle 104 by comparing the vehicle metrics in the vehicle data set database 306 to compliance thresholds (e.g., standards set by a State) stored in the emission standards database 312. In one embodiment, the process utilizes minimums/maximum compliance thresholds to tighten controls in various stages without any new infrastructure using the data logger devices 102. The percentage of emission compliance and the minimums/maximum thresholds may be parameters that are stored in the client rules database 308.

From the comparison, the check compliance module 300 may calculate a percentage of emission compliance or a compliance ratio over time. Based on the compliance ratio, the check compliance module 300 may apply a penalty or benefit to the user 116. For example, assume that a percentage of emission compliance threshold is set at 70% for a particular user 116 in the client rules database 308. If the compliance ratio of a vehicle of the user 116 is determined to be greater than 70% percent compliant over some period (e.g., over 8-12 months), the owner may receive a benefit, such as a carbon credit. If the vehicle is below 70%, then the owner may have to pay a penalty, such as a carbon tax.

The compliance ratio computed for a given vehicle may be automatically submitted to the government entity. In addition, the compliance ratio may be made available to the user through the emission compliance portal or sent directly to the user.

Calculating a compliance ratio of emission compliance over time by the emission compliance module 112 eliminates some aspects of past OBD processes that were based on drive cycles. That is, conventional engine diagnostics techniques relied on the check engine light that take a snapshot of sensor data at the time without the benefit of any historical sensor data. The vehicle did not go through a diagnostic test to find the source of the problem. In contrast, the disclosed embodiments request specific datasets from the data logger devices 102 and the datasets are used to form historical sensor data of what is happening with the vehicle when on the road in real-time.

The remote diagnostics module 302 analyze the vehicle metrics and determines if there is an indicated problem with vehicle's check engine light (CEL). If so, the remote diagnostics module 302 automatically triggers transmission an alert message to both the user and to a designated repair technician. The repair technician can then diagnose the vehicle's check engine light (CEL) issue remotely without the vehicle physically being onsite in the repair bay.

The predictive failure module 303 examines plots of historical sensor data from multiple sensors at the same time and then use the min/max compliance thresholds to determine whether a component is progressing towards a potential failure (e.g., within 20 percent), triggering a warning alert message. The alert message may appear in a GUI of a web portal displayed by the emission compliance portal 114, displayed in a report that is sent electronically to the user 116 and/or to the repair technician, or directly sent to and/or the user 116 and/or to the repair technician.

The processing of vehicle emission data performed by the emission compliance module 112 eliminates the need, cost, and time for users to physically drive to an emission testing facility or self-serve kiosk to comply with federally mandated emission testing programs currently required in approximately 33 States in the USA. The analytics cloud platform 106 can also be adopted for use with States and countries that do not require emission testing but who seek to lower their carbon footprint caused by fossil fuel and alternative fuel vehicles. Accordingly, the check compliance module 300 may be considered the next version of onboard diagnostics, and may be referred to as OBD IV. In addition, use of the compliance module may prevent out of vehicle compliance periods without government intervention.

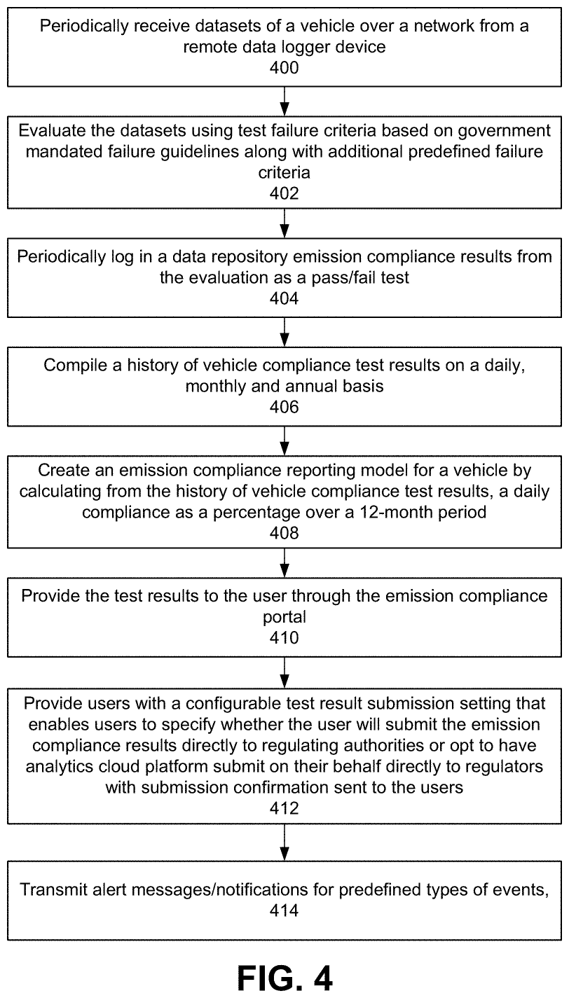

FIG. 4 is a flow diagram of the processing that may be performed by the check compliance module according to one embodiment. The check compliance module 300 periodically receive datasets of a vehicle over a network from a remote data logger device (block 400). In one embodiment, the check compliance module 300 may access the datasets from the data repository 304. For example, the datasets may have been collected multiple times daily by the data logger device and stored in the vehicle dataset database 306. This processing may include evaluation of data comprising the datasets, including check-engine light (CEL) status, codes, code types, code descriptions, readiness monitor supported/non-supported systems, readiness monitor status (ready/not ready-or-complete/not-complete), and any other indicators involving malfunctions or system tampering.

The check compliance module 300 evaluates the datasets using test failure criteria based on government mandated failure guidelines along with additional predefined failure criteria (block 402). Overall, the test failure criteria may include typical failure criteria such as an illuminated CEL, the number of readiness monitors not complete, unexpected non-presence of DTCs, or system tampering. An example of additional predefined failure criteria is that the check compliance module 300 may count a data logger device that is unplugged for one full day, multiple days, or weeks where no readings occur as non-compliant. However, there are circumstances where a re-plugged-in data logger device could determine the vehicle had not moved during that period, which may not be counted as non-compliant during that period unless other issues are detected.

Emission compliance results produced during the evaluation by the check compliance module 300 are periodically logged in the data repository 304 as a pass/fail test (block 404). The results may be logged in the vehicle dataset database 306 periodically, such as once a day towards days end following the last driving trip after KOEO. This represents a dramatic shift from current emission testing programs that test a vehicle once every 12 months or once every 24 months depending on the State.

The check compliance module 300 compiles a history of vehicle compliance test results on a daily, monthly, and annual basis (block 406). In one embodiment, pass/fail test results may be formatted using various calendar color codes (e.g. green for a pass day, red for a fail day).

In one embodiment, the check compliance module 300 may create an emission compliance report for a vehicle by calculating from the history of the vehicle compliance test results, a daily compliance as a percentage over a 12-month period (block 408).

The daily compliance as a percentage over a 12-month period is a threshold that may be stored in the emission standards database 312 for a particular government entity such as a State. For example, one State may specify a 75% annual compliance threshold (9 of 12 months daily pass rate) for meeting or exceeding thresholds before assigned potential incentives to the user. Another less stringent State may specify a 50% compliance threshold (6 of 12 months daily pass rate) is sufficient. Either of these thresholds far exceeds current established compliance thresholds of one test every 24 months (test percentage of 0.001) or one test every 12 months (test percentage of 0.003).

The analytics cloud platform 106 has enough flexibility to comply with any State or Federal testing and reporting program requirements due to the daily comprehensive compliance testing and testing frequency, with daily results available, far exceed current testing standards. The emission compliance model and metrics established by analytics cloud platform 106 provide flexibility for State and Federal regulators to consider in operating their program. For example, the analytics cloud platform 106 enables vehicle self-testing pass/fail compliance with accuracy, while also addressing potential system tampering issues. Alternatively, the analytics cloud platform 106 can annually send pass/fail and the emission compliance reporting model results to the State (on behalf of the vehicle owner/user) annually. Consequently, the analytics cloud platform 106 has built a sliding scale that governments can adopt as options for a more stringent (higher thresholds) or more relaxed (lower thresholds) compliance program.

Regarding incentives for the user, the analytics cloud platform 106 has also developed the first vehicle carbon credit/carbon tax model of its type. The carbon credit/carbon tax model specifies that if a vehicle meets or exceeds emission compliance thresholds, carbon credits can be applied since the platform enables measurement of compliant vehicles on a regular or scalable basis. The current regulatory method of charging a fee for emissions is through a gas tax attached to miles driven, not whether the vehicle is emission compliant within established vehicle emission testing guidelines. Although driving more miles does equate to more emissions, whether a vehicle is officially compliant or not, a non-compliant vehicle has a much greater impact on increasing the carbon footprint while also reducing engine performance, which results in reduced miles-per-gallon and higher maintenance and repair costs. The disclosed embodiments provide a carbon compliance measuring tool where public and private sector fleets and motorists can be rewarded with carbon credits, and other incentives for compliance, while bad actors (non-compliant vehicles below certain thresholds) could pay a carbon tax. As an example, a sliding scale has been created where States can institute carbon credits for compliant vehicles from 75% and above, carbon neutral between 50%-74%, and carbon tax below 50%. Each category has a sliding scale for credit or tax threshold flexibility. Sustainability funds can be directed to this type of program since it is measurable.

The pass/fail test results may be stored in the data repository 304 and provided to the user through a web portal such as the emission compliance portal 114 (block 410). User's may have access to the pass/fail test results through the user's proprietary and secure portal account via the user's computers or mobile devices. As described above, the pass/fail test results may be formatted using various calendar color codes (e.g. green for a pass day, red for a fail day) for ease of viewing.

In one embodiment, the check compliance module 300 may provide users with a configurable test result submission setting that enables users to specify whether the user will submit their vehicles' emission compliance results directly to regulating authorities or will have analytics cloud platform 106 submit on their behalf directly to regulators with submission confirmation sent to the users (block 412). Either way the analytics cloud platform 106 would be acting as the Vehicle Information Database (VID) contractor directly with the State or through the States designated representative. In one implementation, the test result submission setting may be set by the user through the emissions compliance portal 114.

The check compliance module 300 may also transmit alert messages/notifications for predefined types of events (block 416). The alert notifications may be sent with specific codes and descriptions. The events may be related to a vehicle malfunction or other issue preventing the remote compliance feature from working properly beyond an established period, such as a data logger device connection and disconnection. The events may also include a periodic (e.g., monthly) report on overall compliance. Several other alert notifications may be available with most having optional settings through customizable portal features. Upon detection of non-compliance or malfunction, the check compliance module 300 may send an alert message requiring the vehicle user to report to an authorized auto repair shop. In one embodiment, the repair shop may comprise an authorized Private Inspection Facility (PIF) or Emission Repair Facility (ERF) for service and potential on-site manual inspection. The repair shop may also receive the alert message.

Remote Diagnostics Module 302

The remote diagnostics module 302 comprises an automated vehicle health management system that enables users to designate a repair technician to receive automated reports and alerts regarding vehicle health. Engine and emission system data from the user's vehicle are compiled into reports and made available to both the vehicle user and the designated repair technician. This enables the repair technicians to have remote access to vehicle engine and emission data as well as complete history under all driving conditions.

Referencing the data logger device configuration and data processing steps during each trip referenced above, the remote diagnostics module 302 is configured to extract specific data results and display the data results via the emission compliance portal 114 to repair technicians.

The remote diagnostics module 302 may continuously evaluate Parameter IDs (PID) codes directly related to all PID engine and emission modules and plot readings on each of those modules. The remote diagnostics module 302 evaluates the data or all components to determine how the vehicles performing on the road while under load. The remote diagnostics module 302 automatically contacts designated repair technicians and displays anomalies within the vehicle as the anomalies occur through the emission compliance portal 114.

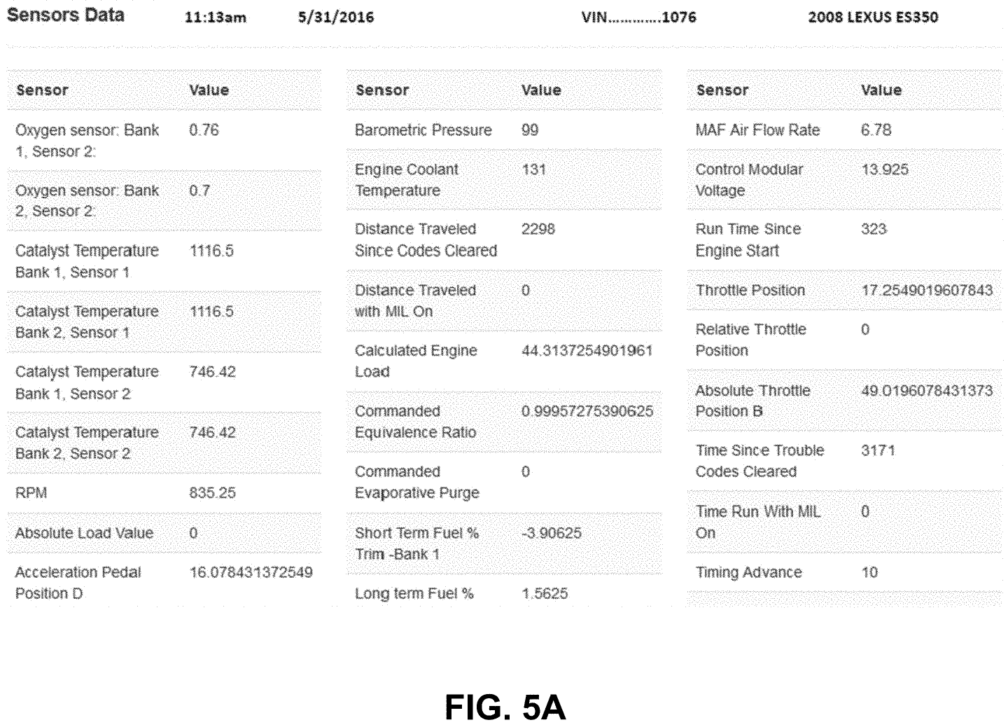

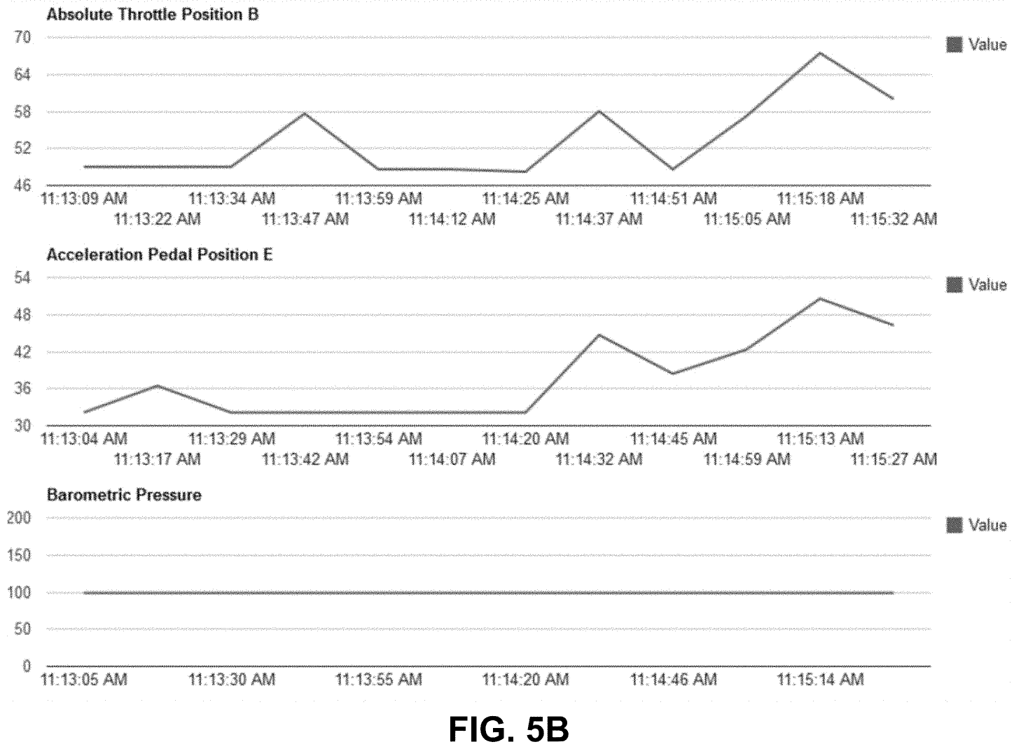

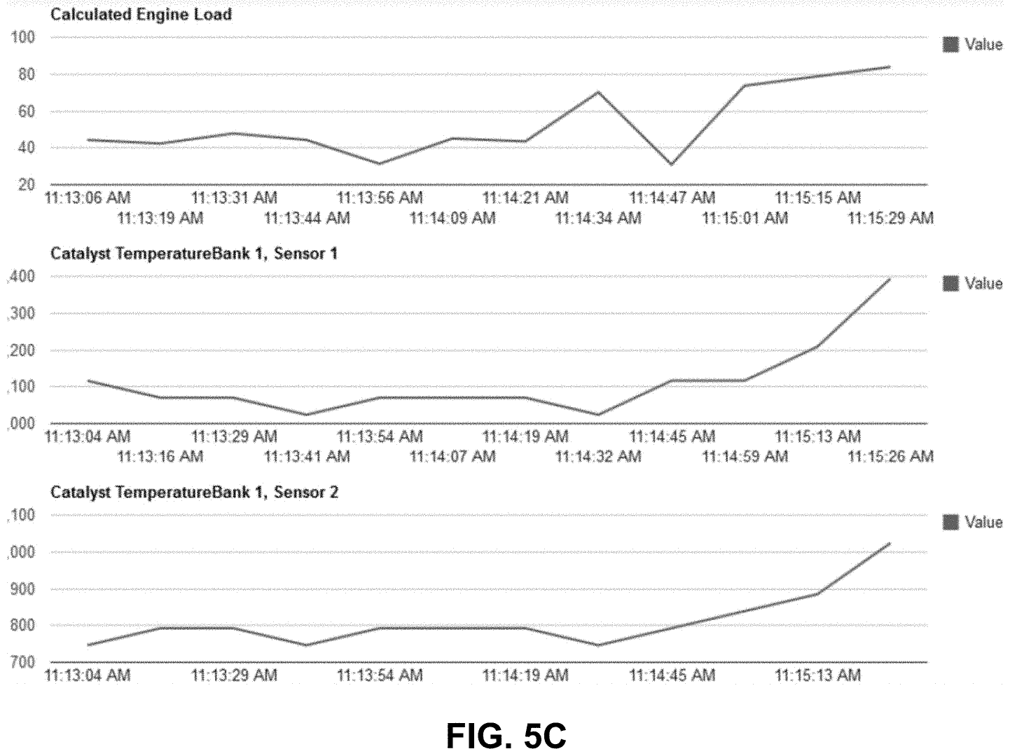

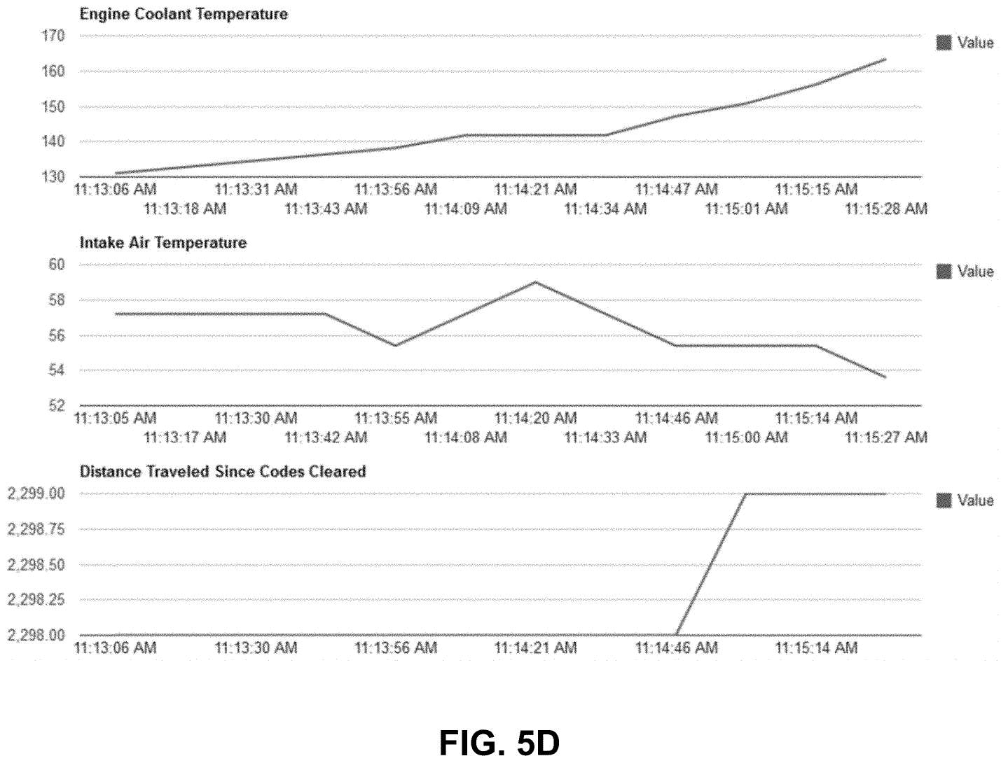

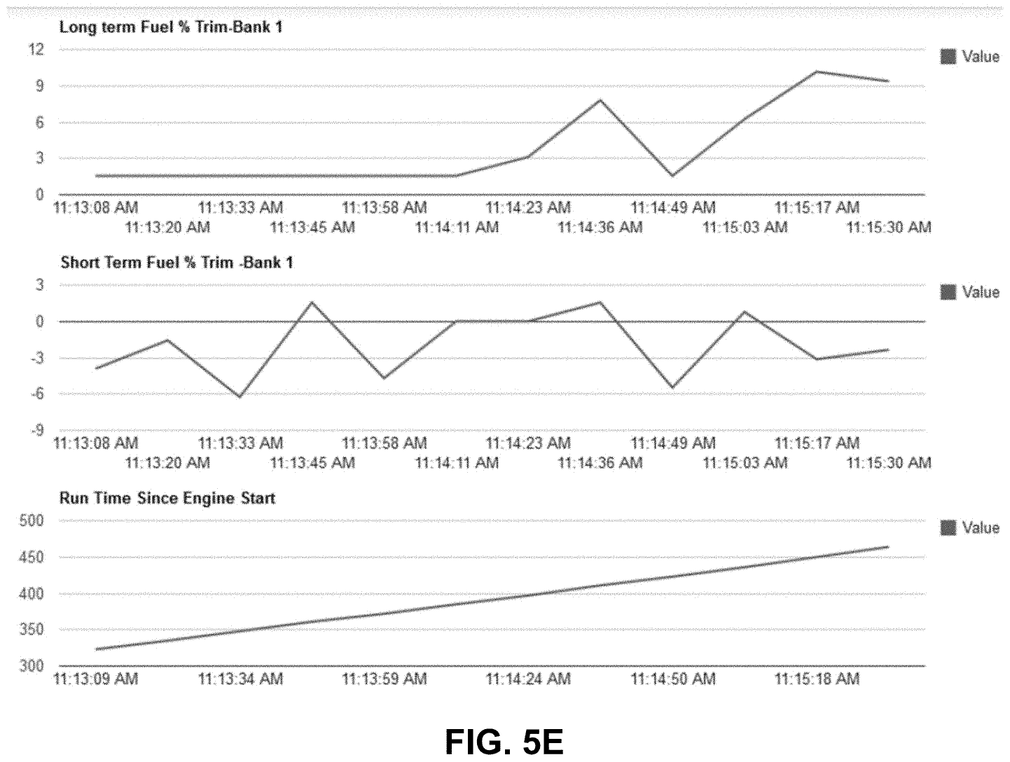

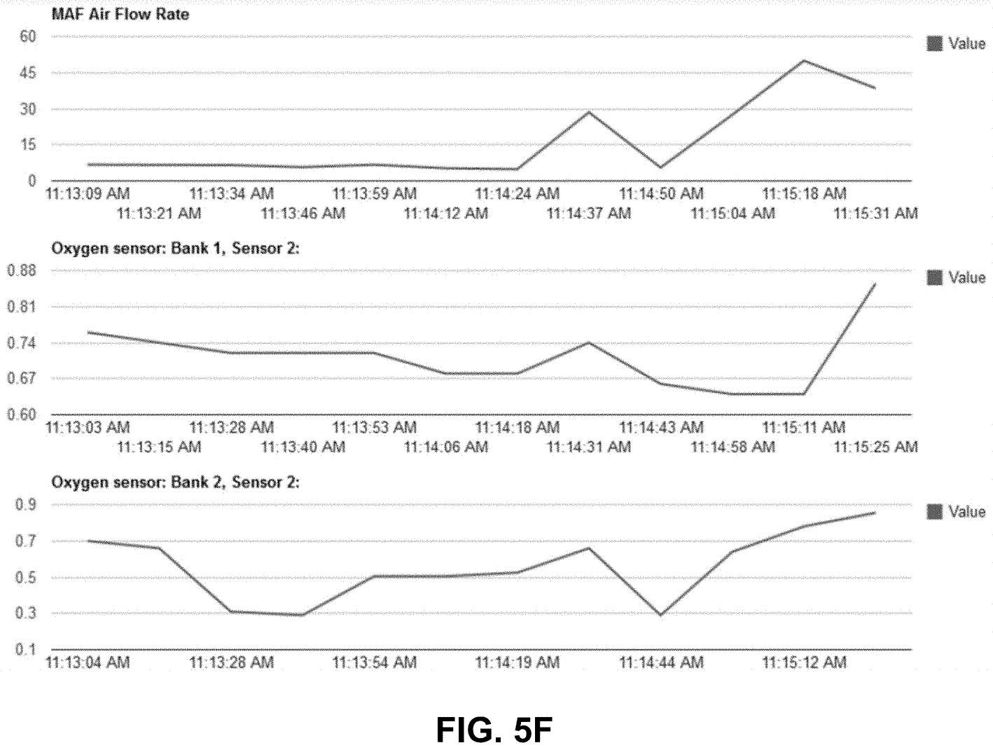

FIGS. 5A-5F are example screen shots of reports produced by the remote diagnostics module 302 showing how engine and emission system data is captured, plotted and displayed. The screen shots demonstrate the data output capabilities of the remote diagnostics module 302. FIG. 5A is a screen shot of an example report displaying various types of vehicle sensor data taken at a specific point in time. FIGS. 5B-5F are screen shots of example plots of a set of the vehicle sensor data over a two-minute driving period.

Evaluating all components enables the remote diagnostics module 302 to narrow the specific source of the problem by determining if the issue is related to the vehicle on-board computer, a sensor monitoring a specific component, or that the actual component is failing. Without having access to information on how the vehicle is performing on the road while under load, the diagnostic process is inadequate. An inaccurate vehicle diagnosis results in an inaccurate repair and a vehicle return to the repair shop, which costs all parties additional time and money.

As an example, assume that a public-safety police vehicle's CEL continued to illuminate following multiple diagnostic and repair efforts by a police fleet's in-house mechanics and several attempts by a dealership. Assume that the police fleet subsequently installed the data logger device 102 in police vehicles, including the one with the CEL problem. After several days, the analytics cloud platform 106 contracts repair tech remotely and the repair tech logs into the emission compliance portal 114 and reviews the data and graphed results from a dashboard displayed by the analytics cloud platform 106. Within a few minutes, the tech identifies an intermittent issue with the Evaporative Purge Valve (EVAP) system and immediately resolves the issue without recurrence. This example illustrates a successful outcome without the vehicle physically at the repair shop taking up expensive bay time and additional repair labor costs.

Remote diagnostics module 302 also handles a further complication mandated by OBDII system. The OBDII system has anti-tampering software that requires resetting the OBDII system with diagnostic equipment following a repair. This resetting process automatically turns off the illuminated CEL (which if on is an automatic emission test failure) and also commands a complete system reset of all system monitors evaluating OBDII modules to a “Not Ready” or “Incomplete” status. Until these monitor systems complete their reset process, which can take days or weeks depending on driving conditions by the owner along with the systems typically needing to see this occurrence three times, a repair is not validated thus not ready for reinspection. Also, depending on the State, a percentage of monitors or all the monitors are required to be complete to pass a retest.

Because the remote diagnostics module 302 uses data in which minimum/maximum data ranges are evaluated multiple times each hour, the remote diagnostics module 302 does not need to wait days or weeks to determine whether a monitor will eventually reset or not. This provides a new and faster, more precise, method of repair validation and emission compliance than previously existed.

Predictive Failure Module 303

The predictive failure module 303 can detect when components begin to deviate from a normal operating range, which is used to indicate the component is beginning the process towards gradual failure using predictive analytics. The predictive failure module 303 tests emission systems and component parameters for emissions failure through drive ranging. Every emissions component and emission system has an operating parameter that provides a baseline for vehicle test during a drive cycle that measures individual component and systems for compliance. If a component fails, a diagnostic trouble code (DTC) is set and when an emission system fails, a Readiness Monitor failure will be set. The operating parameter test results are known as Mode 06.

The predictive failure module 303 compares the Mode 06 test results for the components and systems and compares the Mode 06 test results to the corresponding operating parameter to compute a percentage of failure. As a component or system approaches a threshold percentage, the predictive failure module 303 activates a warning that is electronically sent to the user requesting the user to set a repair appointment. As one example, as an operating parameter of a system or component approaches 15% percentage of failure, a yellow warning may be sent to the user. As the operating parameter of a system or component approaches 10%, an orange warning may be sent to the owner requesting the user to find a garage immediately. As the operating parameter of a system or component approaches 5%, an orange warning may be sent to the owner requesting the user to pull over and call for assistance.

The warning may be sent as a text message, an email, an automated voice call, or through a mobile application alert system used to notify vehicle owners of pending failure warnings. In this embodiment, the analytics cloud platform may include a mobile application for download by users so the user may review test results and alert messages through the mobile application.

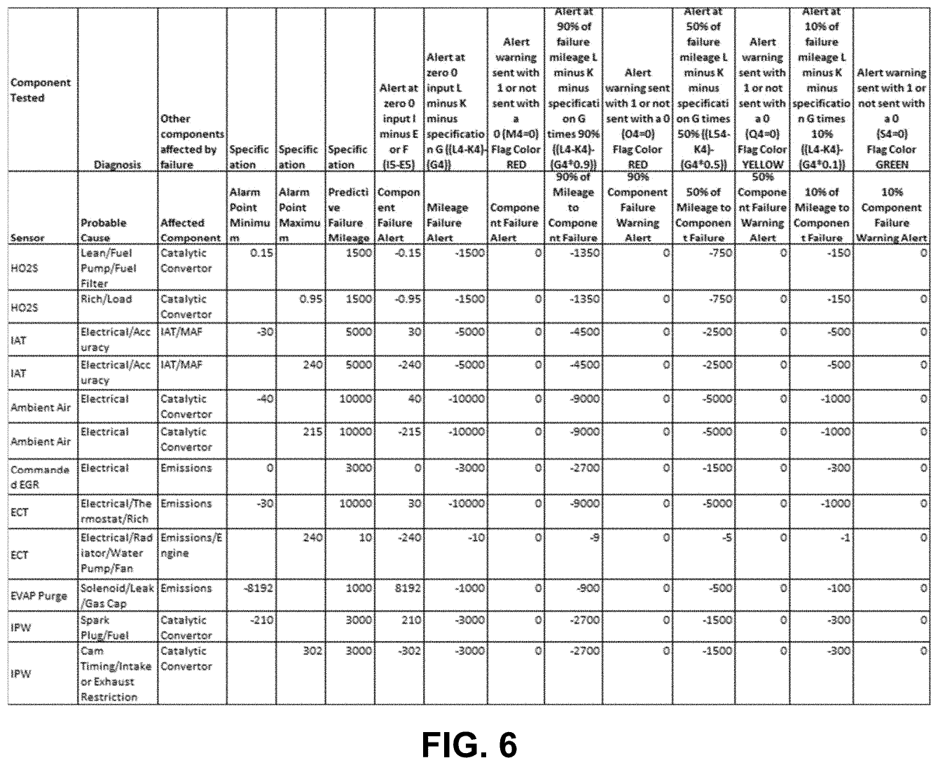

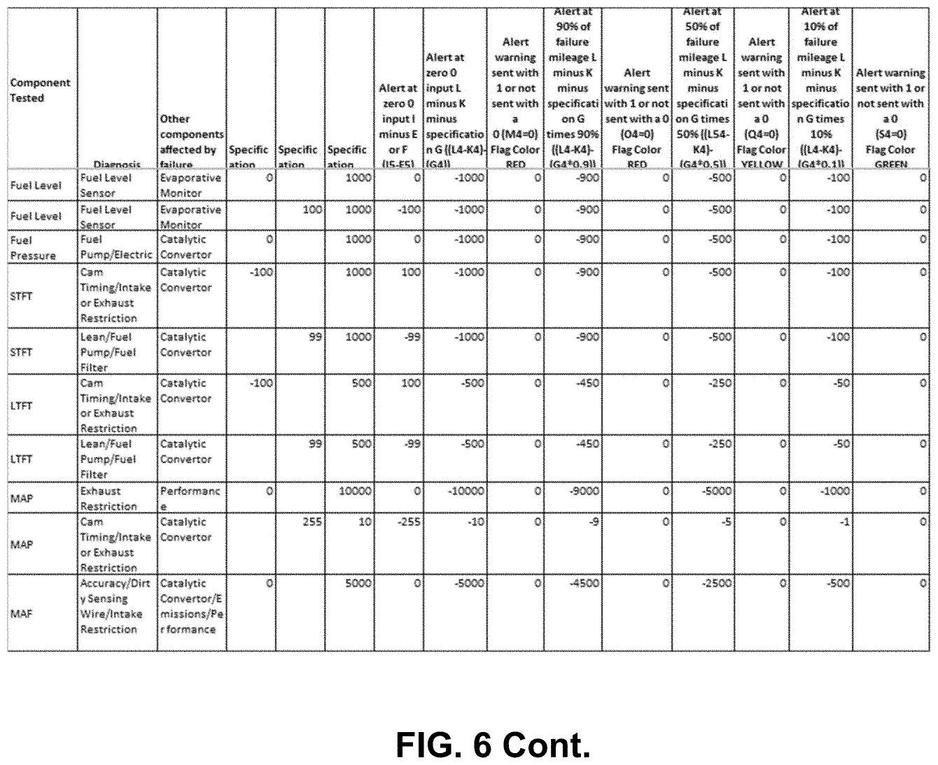

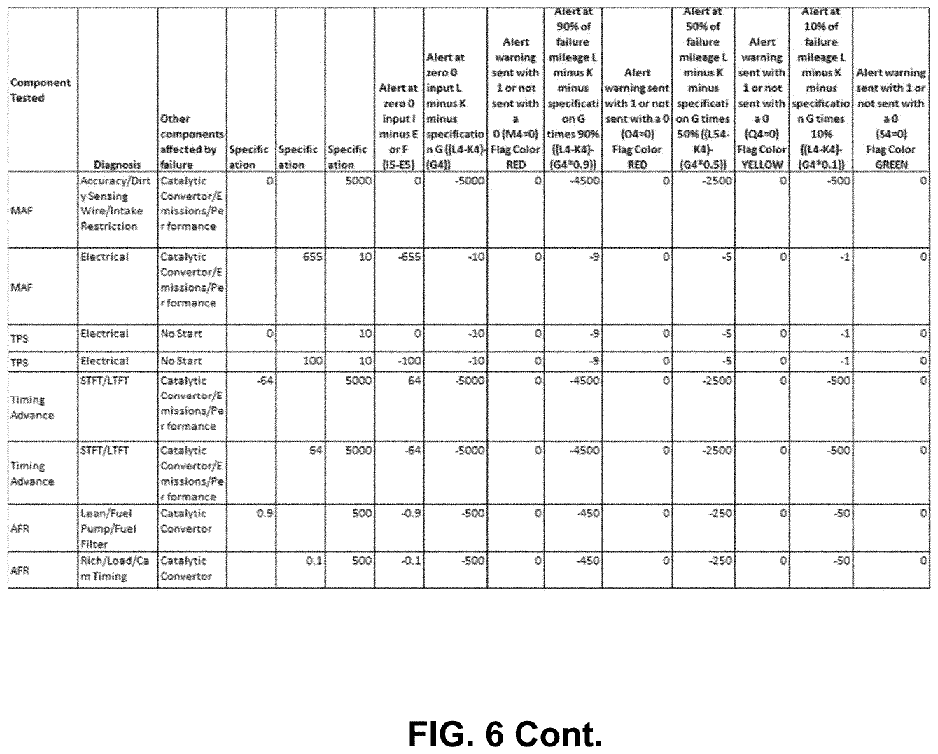

FIG. 6 is a table listing components that may be tested for predictive component failure and percentage of failure calculations according to one implementation. The emission compliance module 112 may compare the parameter value of a tested component to minimum/maximum alert ranges multiple times each hour. As the parameter value of a component approaches the minimum or maximum alert, the predictive failure module 303 begins to record mileage. As the recorded mileage approaches predefined percentages, such as 10%, 50%, 90% and at 100% of predictive failure mileage thresholds, alerts are sent to the user to send the vehicle in for repair.

As the parameter value of a component approaches ‘Minimum Alert’ or ‘Maximum Alert’ threshold, the parameter value is subtracted from ‘Minimum or Maximum Alert’ threshold. When the ‘Component Failure Alert’ value equals 0, mileage recording starts. As the recorded mileage approaches the ‘Predictive Failure Mileage’ value, alerts are sent. By subtracting ‘Mileage End’ from ‘Mileage Start’ and then subtracting the ‘Predictive Failure Mileage’ value and then multiplying by 10%, 50%, 90% and 100%, alerts are sent to the user to send the vehicle in for repair.

In order to prevent false alerts for components that would normally have 0 the Predictive Mileage Failure value for Comprehensive Component Monitor Failure DTC, the Predictive Mileage Failure value is set to 10 miles even though the failure is 0 miles and immediate repair required. Alert 1 means an Alert is on and warning has been sent. Alert 0 means Alert is not on and Alert has not been sent.

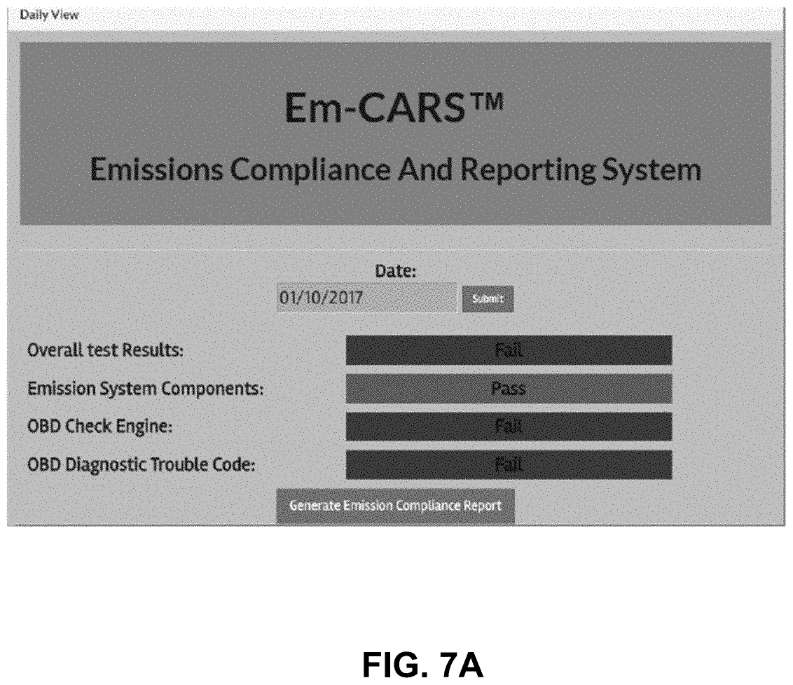

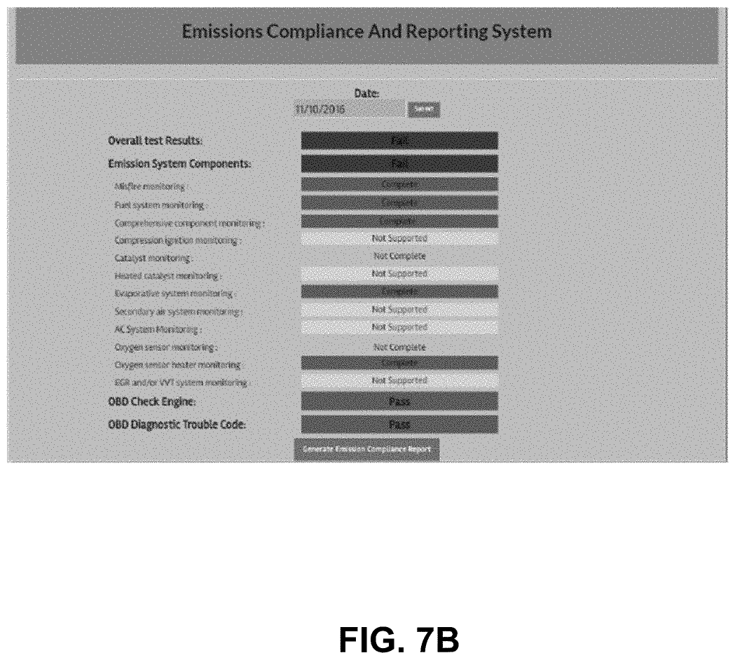

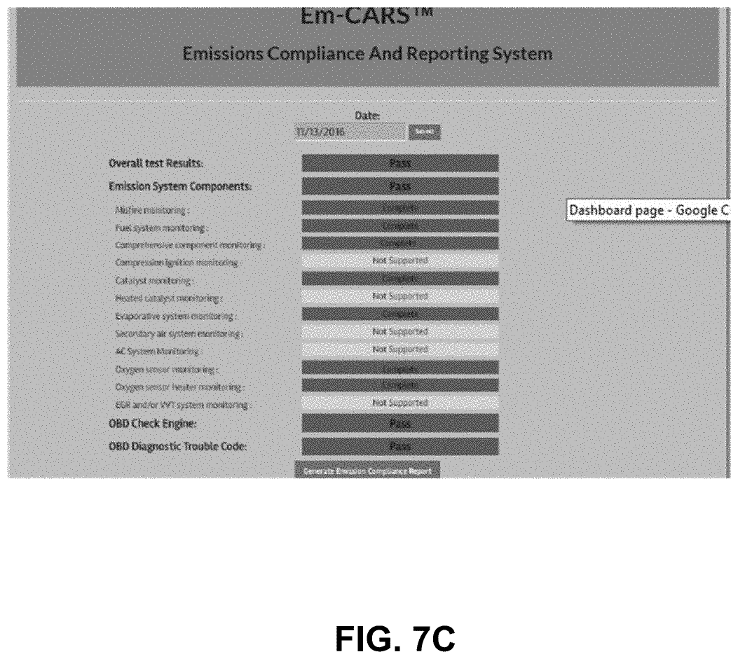

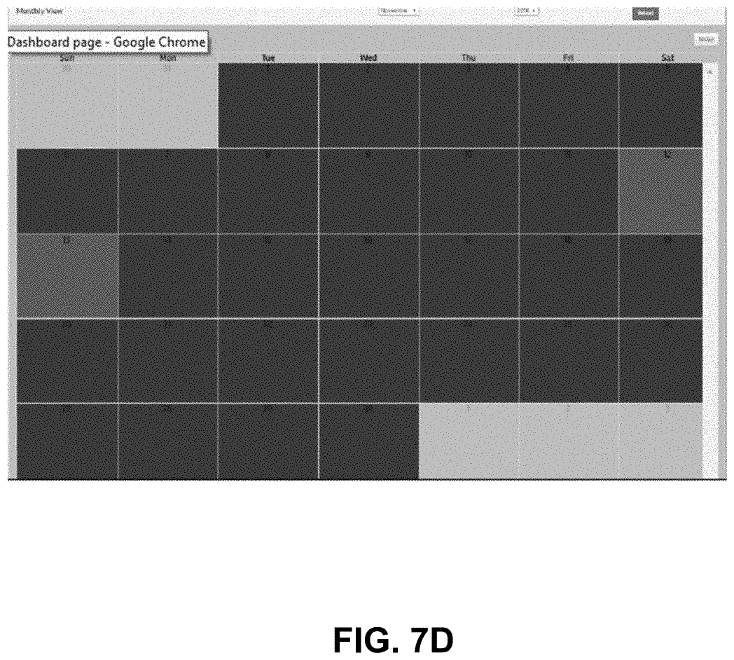

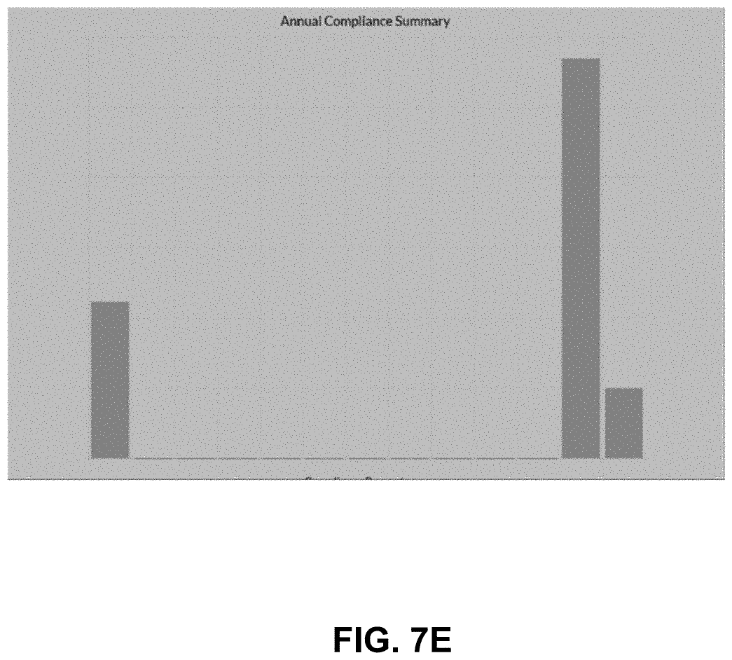

FIGS. 7A-7E are screenshots of an example user interface of the emission compliance portal 114 for displaying emission compliance reports to the users. After logging into the web portal, the emission compliance portal 114 may display a dashboard of an overall vehicle test result for a particular date. FIG. 7A illustrates a screenshots of an example daily view screen of an emissions compliance report of pass/fail test results. In this example, the daily view screen displays overall test results, emission system components test results, OBD check engine test results, and OBD diagnostic trouble code test results. In this particular example, only the emission system components passed the tests. Also, the example shows the pass/fail test results are color coded, red for fail and green for pass/complete.

FIG. 7B illustrates a screenshots showing that one or more of the test results shown in the daily view screen may be selected (clicked) to display further detail about that test. In this example, the user has selected the emission system components test, which displays the test results for the list of components tested.

FIG. 7C is a screenshots illustrating the example daily view screen of the emissions compliance report for another day in which the user was able to repair the car and pass the tests.

FIG. 7D illustrates a screenshots of an example monthly calendar view screen of the emissions compliance report showing which days the vehicle passed the overall test results (green) and which days the vehicle failed the overall test result (red). FIG. 7E illustrates a screenshots of an example of an annual compliance summary report in which mostly test results are shown as a bar graph.

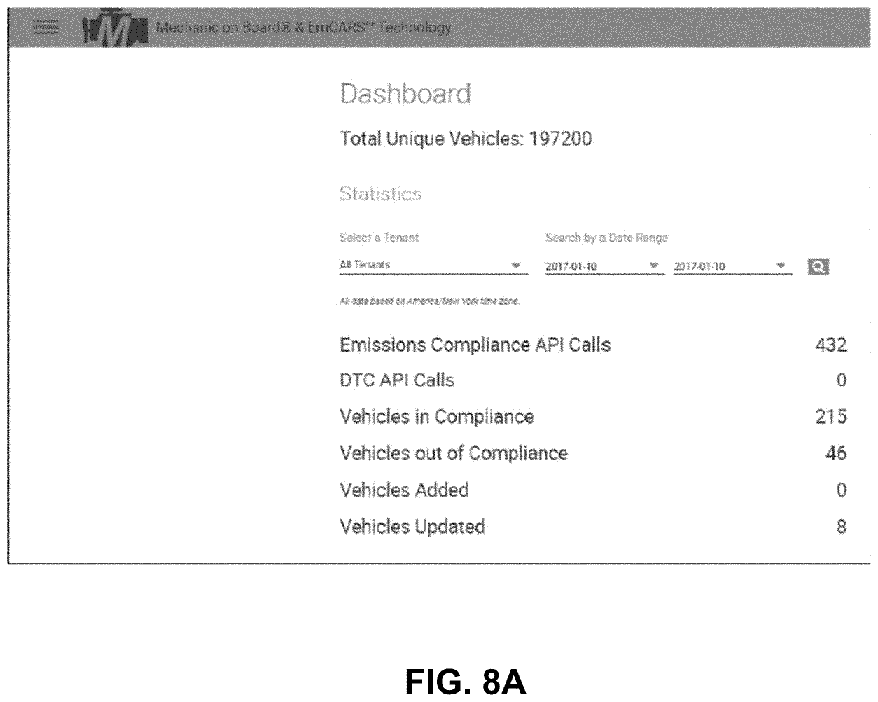

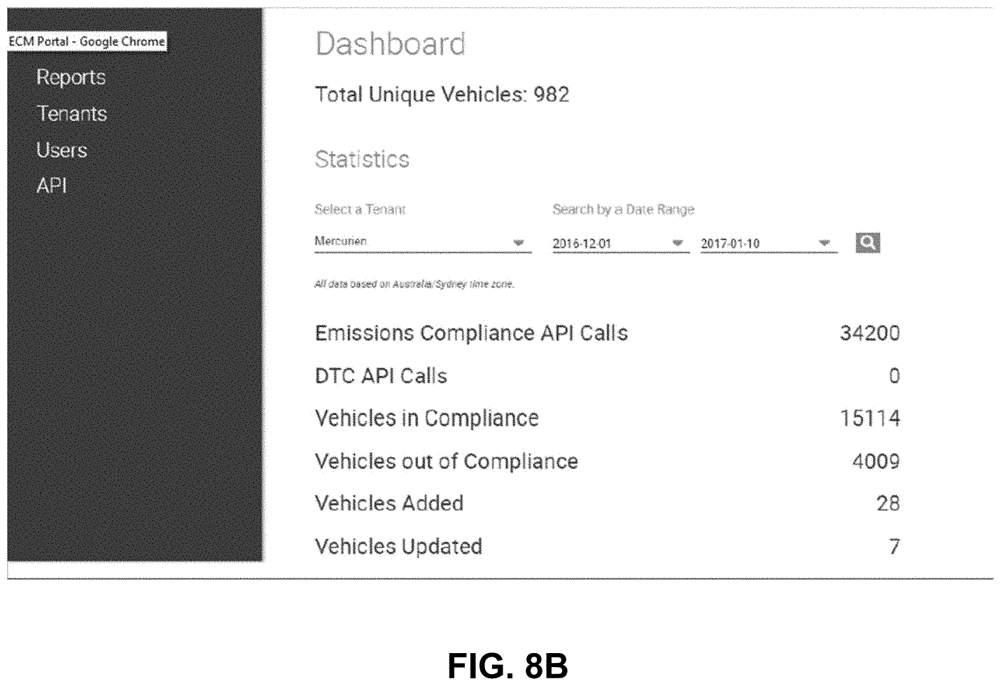

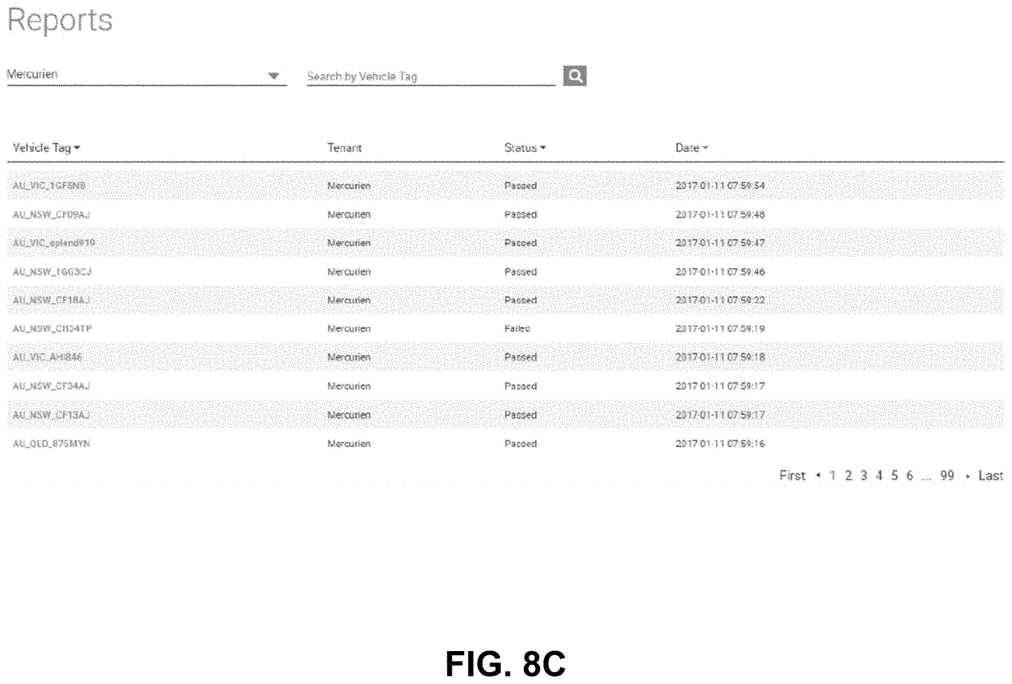

FIGS. 8A-8C are screenshots of an example user interface for an administrative web portal of the analytics cloud platform 106 for displaying compliance statistics across multiple vehicle fleets. FIG. 8A is a screenshot of a main dashboard screen showing the total number of unique vehicles and overall compliance statistics compiled for all of the vehicle fleets. In this example, the compliance statistics may include emission compliance API calls, DTC API calls, vehicles and compliance, vehicles out of compliance, vehicles added to the system and vehicles updated. The main dashboard screen also includes user interface (UI) controls to allow the user to display compliance statistics for “All Tenants” (vehicle fleets) or a selected tenant and/or to search by a date range.

FIG. 8B is a screenshot of the main dashboard screen after the user selects a particular tenant or vehicle fleet. The overall compliance statistics are updated to show values for just the selected vehicle fleet. The main dashboard screen may also include a navigation pane that allows the user to select and navigate to “reports”, “tenants”, “users” and “API”.

FIG. 8C is a screenshot of a report generated for the selected tenant of FIG. 8B. In this example, the report is generated by searching by vehicle tag and displays a list of vehicle tags comprising the selected fleet and overall test results.

An analytics cloud platform for remote vehicle onboard diagnostics (OBD) and inspection maintenance (UM) has been disclosed. The analytics cloud platform receives raw data from the vehicle engine and emission systems transmitted from data logger devices and processes the data using data analytics. The data analytics produces emission/engine compliance test results that are accessible to users through a web portal of private online accounts. The test result provide users and repair technicians with an ongoing history regarding the health of their vehicles.

The analytics cloud platform impacts the three largest cost areas of vehicle ownership during the vehicle's total lifecycle as an asset. This is commonly referred to as the Total Cost of Ownership (TCO). In order of magnitude, the three top cost areas that MoB impacts are: 1) depreciation 2) fuel 3) maintenance & repairs. Fuel savings are realized by the analytics cloud platform through consistent evaluation of the engine system and related components in order to uncover inefficiencies causing fewer miles per gallon. Maintenance and repair cost are avoided through generated reports and preventive maintenance alerts. The reports and alerts provide early warnings to help determine if, or when, an issue is affecting the on-board computer, sensors, or components affecting lower fuel economy. Such preventive maintenance early warning alerts differ from “scheduled maintenance”, where periodically (at a pre-determined time) the vehicle enters a repair bay where both bad parts and good parts are replaced. Instead, the analytics cloud platform allows vehicle owners to preemptively address issues prior to becoming major repairs, and results in replacing or repairing only what is necessary. Proactive maintenance and vehicle care is also defense against depreciation to extend the vehicle lifecycle, which can dramatically increase the return-on-investment (ROI) for commercial fleet owners and motorists.

Finally, proactive maintenance not only saves time and money, it also lowers harmful carbon emissions. A well maintained engine and emission system results in a cleaner, more environmentally friendly vehicle.

The present invention has been described in accordance with the embodiments shown, and there could be variations to the embodiments, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims.

We claim:

1. A method of remotely diagnosing a vehicle, the method comprising:
periodically receiving, by one or more servers, vehicle metrics transmitted wirelessly over a communication network from a remote data logger device in the vehicle;
analyzing, by the one or more servers, the vehicle metrics to determine at least one of i) whether the vehicle is compliant with predefined emissions standards, and ii) whether a component of the vehicle is progressing towards a failure based on predictive analytics; and
electronically communicating, by the one or more servers, results of the analysis to a user through a web portal or through alert messages.

2. The method of claim 1 further comprising analyzing the vehicle metrics to perform remote onboard diagnostic (OBD) inspection maintenance (I/M).

3. The method of claim 2 further comprising performing the OBD I/M in real-time while the vehicle is in operation.

4. The method of claim 2 further comprising analyzing the vehicle metrics to perform pass/fail emissions testing, engine diagnostics, and reporting to State I/M emissions programs, and any combination thereof.

5. The method of claim 1 further comprising receiving the vehicle metrics as OBD test records comprising raw OBD data.

6. The method of claim 1 further comprising transmitting the alert messages when specific data fields in the vehicle metrics have values that exceed predefined thresholds.

7. The method of claim 6 further comprising transmitting the alert messages to an owner of the vehicle and to a designated repair technician.

8. An analytics platform, comprising:
a server computer system; and
memory storing instructions that when executed by the server computer system, cause the server computer system to perform operations comprising:
periodically receive vehicle metrics transmitted wirelessly over a communication network from a remote data logger device in a vehicle;
determine emissions compliance of a given vehicle by comparing the vehicle metrics to compliance thresholds;
based on the comparison, calculate a compliance ratio of emission compliance over time for the vehicle;
apply a penalty or a benefit to a user of the vehicle based on the compliance ratio of emission compliance;
automatically submit the compliance ratio of emission compliance to a government entity; and
make the compliance ratio of emission compliance available to the user through a web portal or by sending the compliance ratio of emission compliance directly to the user.

9. The analytics platform of claim 8 wherein the server computer system analyzes the vehicle metrics to determine if there is an indicated problem with a check engine light (CEL), and if so, automatically trigger transmission of an alert message to the user, to a designated repair technician or both.

10. The analytics platform of claim 8 wherein the server computer system examines plots of historical sensor data from the vehicle metrics at the same time and compares the historical sensor data to minimum/maximum compliance thresholds to determine whether a component is progressing towards a potential failure, which if so, trigger transmission of an alert message to the user, a designated repair technician or both.

11. The analytics platform of claim 8 wherein the vehicle metrics comprise raw on-board diagnostics (OBD) data compiled into an OBD test record, the raw OBD data including OBD Parameter ID (PID) codes.

12. The analytics platform of claim 8 wherein the vehicle metrics are polled several times per hour.

13. A non-transitory computer-readable medium containing program instructions for implementing remote on-board diagnostics (OBD) diagnostics, which when executed by a processor, the program instructions cause the processor to:
periodically receive datasets of a vehicle over a network from a remote data logger device;
evaluate the datasets using test failure criteria based on government mandated failure guidelines along with additional predefined failure criteria;
periodically log, in a data repository, emission compliance results from the evaluation as a pass/fail test;
compile a history of vehicle compliance test results on a daily, monthly and annual basis;
create an emission compliance report for the vehicle by calculating from the history of vehicle compliance test results, daily compliance as a percentage over a 12-month period; and
provide pass/fail test results to a user of the vehicle through a web portal.

14. The non-transitory computer-readable medium of claim 13, wherein data comprising the datasets includes check-engine light (CEL) status, codes, code types, code descriptions, readiness monitor supported/non-supported systems, readiness monitor status, or any other indicators involving malfunctions or system tampering.

15. The non-transitory computer-readable medium of claim 13, wherein the test failure criteria includes an illuminated CEL, a number of readiness monitors not complete, unexpected non-presence of Diagnostic Trouble Codes (DTCs), or system tampering.

16. The non-transitory computer-readable medium of claim 13, wherein an analytics cloud platform provides the user with a configurable test result submission setting that enables the user to specify whether the user will submit the emission compliance results for the corresponding vehicle directly to regulating authorities or will have the emission compliance results submitted on their behalf directly to the regulating authorities.

17. The non-transitory computer-readable medium of claim 13, wherein an alert message is transmitted to the user for predefined events.

18. The non-transitory computer-readable medium of claim 13, wherein the pass/fail test results in the emission compliance report are formatted using calendar color codes comprising a first color for a pass and a second color for a fail.
